(19) United States
(12) Patent Application Publication
(10) Pub. No.: US 2005/0056231 A1
(43) Pub. Date: Mar. 17, 2005

(54) Spring perch

(76) Inventor: Michael Edward Buonocore, Milford, CT (US)

Correspondence Address: MICHAEL E. BUONOCORE, 51 THOMPSON ST., MILFORD, CT, 06460, US

(21) Appl. No.: 10/936,066

(22) Filed: Sep. 9, 2004

Related U.S. Application Data
(60) Provisional application No. 60/502,239, filed on Sep. 12, 2003.

(51) Int. Cl. A01K 61/02

(52) U.S. Cl. 119/468

(57) ABSTRACT

The present invention is a pet bird perch. The main object or preferred embodiment of the present invention is a perch body that is connected to the birdcage by means of a flexible connection rather than the common rigid nut and bolt apparatus or other rigid means of connection. The flexible connection allows for random movement of the perch body under the birds own weight similar to a tree branch in the wild, not only front to back motion similar to a bird swing currently available. The flexible connection can be an extension spring or other flexible “bungee” like object with a protective cover or insert to protect the birds feet from becoming entangled if the spring is over-extended. The perch body should be of a natural piece of wood or tree branch, with the bark in tact, of various length and diameter. The perch body can also be made of other material such as hardwood dowels, manzanite, high-density plastic, colored concrete and rope. The present invention is not limited to those materials listed. All objects and materials are non-toxic to the bird.

### BACKGROUND OF THE INVENTION

The present invention relates to the pet product industry and more specifically to a pet bird perch for the birds cage.

### PRIOR ART

| | | |
|---|---|---|
| 5,351,647 | October 1994 | James R. Frenelle |
| 5,315,957 | May 1994 | Robert J. Garay, Bert W. Stewart |
| 5,588,397 | December 1996 | E. Kimble Johnakin, III |
| 5,887,542 | March 1999 | Alex Sladowski |
| 6,374,772 | April 2002 | Thomas Elwood Brandt |
| D0391,690 | March 1998 | Debbie Edlebeck, David J. Day |
| D386,834 | November 1997 | Ofer Nissim, Marc Goldblatt |
| 4,627,384 | December 1986 | Marc A. Courteau |
| 4,116,422 | September 1978 | Dieter F. Koerner |
| 5,099,796 | March 1992 | James R. Morgan |
| 2,707,936 | May 1955 | Howard C. Kiehl |
| 5,487,360 | January 1996 | Yeong J. Yau |

The conventional bird perch is generally provided with a perch body upon which the bird sits. The perch body is fastened to the birdcage by a nut and bolt type apparatus, or other rigid connection of the perch body to the birdcage. The majority, if not all, of pet bird perches currently on the market today use a rigid connection to secure the perch body to the birdcage. The common method of fastening these perches to the cage is by using a nut & bolt type apparatus. This type of connection provides a strong and stable connection of the perch body to the birdcage and does not allow for any movement of the perch body. Such a product does not allow for any movement of the perch body or simulate the natural movement of a tree branch or other flexible objects a bird may perch on in the wild. There are however, swing type devices that attach to the cage but only allow forward and backward motion, similar to a swing on a playground.

The present invention relates to a pet bird perch, which mimics the flexible movement of a tree branch in the wild under the birds' own weight. The present invention uses a flexible, “spring or bungee” like connection for securing the natural wood perch body to the birdcage. This type of fastening method allows for random and flexible movement of the natural wood perch body under the birds' own weight. When a bird flies up to and perches on the branch of a tree or bush in the wild, there is a series of complex up and down and side-to-side motion imparted to the branch, which absorbs the energy by the bird. It is well documented that such a free range of movement by a natural tree branch, and simulated by the present invention, is vital to the health and wellness of a pet bird for many reasons including helping the bird to develop strength and dexterity as well as providing exercise and developing balancing skills. Pet bird perches currently on the market do not reproduce this type of movement. The are bird swings available but only allow front to back movement.

Many perches on the market today are also constructed of non-destructive materials such as hardwood dowels, manzanite, high-density plastic, colored concrete and rope. It is well document that birds are intelligent and naturally curious creatures. Their curious nature also makes them very destructive, picking and chewing at everything. Therefore, a bird perch should be made of material that will allow the bird to pick and chew at it. If they do not have human interaction, toys or other objects to keep them occupied, they will resort to self-mutilation by picking out their feathers and/or develop neurological problems and become “stir crazy”. The natural wood branch, in the preferred embodiment of the present invention, will allow the bird to keep occupied by stripping the bark and chewing the wood. There are some perches on the market made of a natural tree branch but have the rigid nut and bolt type connection previously mentioned. As mentioned above, most perches on the market are made of material that do not allow the bird to chew at it, thereby discouraging their naturally curious behavior. The present inventions perch body can also be constructed of these other materials while utilizing the flexible, spring-like method for securing it to the birdcage. The preferred embodiment of this invention is of a piece of natural tree branch for the perch body and a flexible “spring or bungee” like connection between the perch body and birdcage.

### DESCRIPTION OF RELATED ART

U.S. Pat. No. 5,351,647 October 1994 James R. Frenelle

This prior art and application depicts the standard perch body constructed of a hardwood dowel. The first disadvantage of this perch is that the hardwood dowel has a slot or void at each. This slot or void in the dowel at each end is positioned between vertical bars of the birdcage. Once inserted between the vertical bars, the perch becomes rigid and does not move. The second disadvantage is that the perch body is made of a hardwood that the bird cannot chew for reasons previously mentioned. The third disadvantage is that the perch body is the same diameter throughout the length of the body. Birds spend their entire life on their feet. It is well documented that pet bird perches that vary in diameter help to stretch and exercise the bird's feet as it moves along the perch body.

U.S. Pat. No. 5,315,957 May 1994 Robert J. Garay, Bert W. Stewart

This prior art and application depicts a perch body constructed of a predetermined length of uncovered and exposed twisted multi-strand, natural, untreated non-cotton fiber rope and a nut and bolt type of apparatus for securing to the rope perch body to the cage. The first disadvantage of this perch is that the rope perch body is the same diameter throughout the length of the body. The perch body should vary for reasons previously mentioned. The second disadvantage is that the rope perch body is secured to the cage by a nut and bolt apparatus that inhibits movement of the perch body. One advantage of this perch is that the rope perch body and can maneuvered into various positions by a person but not the bird. However, it stays in that position until a person changes it. The rope body is a series of non-cotton strands woven together that form a semi rigid yet maneuverable object. This perch does not move in random motion under the bird's own weight.

U.S. Pat. No. 5,588,397 December 1996 E. Kimble Johnakin, III

This prior art and application depicts a perch body of a predetermined length and secured to the birdcage by a nut and bolt type apparatus. The first disadvantage of this perch is that the perch body is of minimal length and does not extend between the vertical bars of the birdcage thereby limiting the movement of the pet bird. The second disadvantage is that the perch body is made of an abrasive, concrete resin type material that is hard on the birds' feet. The third disadvantage is that the perch body is secured to the cage by a nut and bolt apparatus that limits movement of the perch body.

U.S. Pat. No. 5,887,542 March 1999 Alex Sladowski

This prior art and application depicts a perch body referred to as a “Treat Holder” and not a bird perch. However, it appears that it can be used as a bird perch. A disadvantage of this invention is the nut and bolt type apparatus for reasons previously mentioned.

U.S. Pat. No. 6,374,772 April 2002 Thomas Elwood Brandt

This prior art and application depicts a Bird Perch Holder that connects to a birdcage and whereby the perch body is inserted and secured. The disadvantage of this invention is that the perch body becomes rigid once secured in the Bird Perch Holder. This is not preferred for reasons previously mentioned.

Patent Number D0391,690 March 1998 Debbie Edlebeck, David J. Day

This prior art and application depicts an ornamental Bird Perch Swing. A similarity of this design to the present invention is that is has some flexibility if constructed with a chain link as shown in the drawings. However, it does not allow for true random movement only front to back or side to side as a typical bird swing. From looking at the drawings, an obvious difference between this invention and said invention is the ornamental blocks over the chain links.

Patent Number D386,834 November 1997 Ofer Nissim, Marc Goldblatt

This prior art and application depicts a perch of circular design. The first disadvantage of this type of design is that it limits the space for the bird to perch. The bird can only perch on the bottom of the circular perch. The second disadvantage is that the circular perch is the same diameter throughout and not preferred for reasons previously mentioned.

U.S. Pat. No. 4,627,384 December 1986 Marc A. Courteau

This prior art and application depicts a Bird Tree Apparatus. The obvious difference here from said invention is that it is a “tree-like” structure with randomly located fixed dowels that act as individual perches.

U.S. Pat. No. 4,116,422 September 1978 Dieter F. Koerner

This prior art and application depicts a suspended Climbing Gymnastic Apparatus. The main difference with this invention is that it is constructed of a series of vertical elements that make up a “ladder” type apparatus. These elements are connected together by rope or string. Another difference is that each element does not move independently of each other because they are connected by a rope or string.

U.S. Pat. No. 5,487,360 January 1996 Yeong J. Yau

This prior art and application depict a Perching Rod similar to U.S. Pat. No. 5,315,957 previously explained in this application.

### SUMMARY OF THE INVENTION

For the foregoing reasons, the primary object of this invention is to provide a flexible “spring or bungee” like, non-rigid connection between a perch body and the birdcage to allow the perch body to move and sway under the birds own weight and mimic a natural tree branch in the wild as a bird flies up to and perches on the branch. This type of connection will allow the perch body to move randomly, not only front to back like a pet bird swing.

The preferred embodiment of this pet bird perch consists of three (3) primary elements.
1. The first and most important element, in the preferred embodiment, is the connection method between the perch body and the birdcage. Said connection is an object or material which allows a flexible “spring or bungee” like connection rather than the standard nut and bolt apparatus commonly found on most pet bird perches. Said object could be, but not limited to, an extension spring or bungee cord type material.
2. The second element in the preferred embodiment is the perch body made of a natural piece of tree branch. Said perch body can be made of, but not limited to, material currently used for a perch body such as hardwood dowels, manzanite, high-density plastic, colored concrete and rope.
3. The third element of the preferred embodiment is a protective object or material for the “spring or bungee” like connection to protect the birds' feet from becoming entangled in said connection. Said element is needed if an extension spring or other object which is “stretchable” or “extendable” and has gaps or open space, is used for said connection in item 1 above. This will eliminate the possibility of the bird's feet becoming entangled within the gaps of the spring. Said element can be made of, but not limited to, a piece of pvc plastic or metal tube or other non-toxic and non-destructive material.

### BRIEF DESCRIPTION OF THE DRAWING

FIG. 1 is a perspective view of the present invention

### DETAILED DESCRIPTION OF THE PREFERED EMBODIMENT

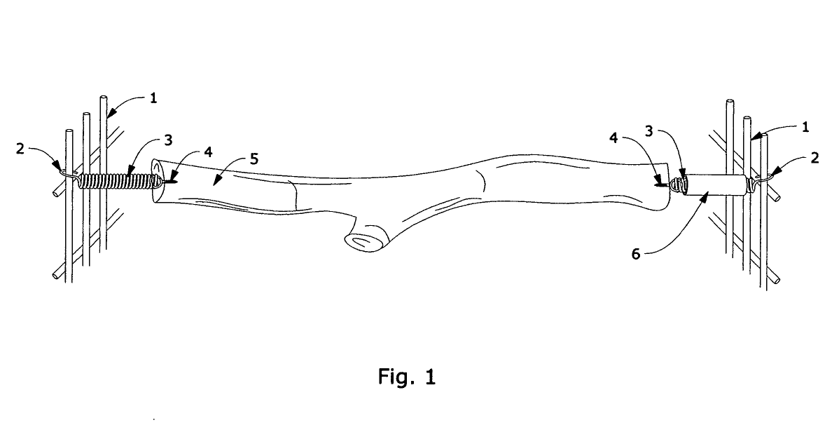

Referring to FIG. 1, there is provided in accordance with the present invention a pet bird perch. The present invention as a whole is comprised of an extension spring or “spring-like” object 3, an eyelet or setscrew 4, the perch body 5 and the protective object 6.

The eyelet or setscrew 4, if used, preferably of stainless steel or other non-destructive and non-toxic material, is inserted into the perch body 5 in order to secure or “set” the perch body into position for connection to the extension spring 3. The extension spring 3 is connected at one end of said spring, to the eyelet or set-screw 4 and the opposite end of said spring, to the vertical bars 1 or horizontal bars 2 of a birdcage by “hooking” the end of the extension spring 3 around the bars. The extension spring 3 is inserted into the protective object 6. As an option, the protective object 6 can be inserted into the center void of the extension spring 3.

It is preferred that the extension spring 3 be of stainless steel or other non-destructive and non-toxic material to the bird. The extension spring 3 should have a tension related to the weight of the pet bird as to allow the appropriate amount of flexible and random movement of the perch body 5 under the birds' own weight. If other objects are used to created a flexible, “spring like” connection, said objects should also be of non-destructive, non-toxic material to the bird and of the appropriate tension.

It is preferred that the eyelet or setscrew 4, if used, be of stainless steel or other non-destructive and non-toxic material to the bird. The eyelet or setscrew 4 can be eliminated if the extension spring 3 is connected directly to the perch body 5.

It is preferred that the perch body 5 be of a natural piece of non-toxic wood species in varying length and diameter throughout the length of the perch body 5. The perch body 5 can also be made of other materials previously mentioned such as hardwood dowels, manzanite, high-density plastic, colored concrete, rope or other materials that are non-toxic to pet birds.

1. A pet bird perch comprising:
a perch body for the bird to perch or sit on; and
a flexible means to connect or attach said perch body to the birdcage; and
a protective object or material attached to said flexible means.

2. A perch body according to claim 1 comprising:
a member of various length and diameter; and
a member of natural wood, hardwood, manzanite, high-density plastic, colored concrete, rope or other materials that are non-toxic to pet birds.

3. A flexible connection means according to claim 1 for attaching said perch body of claim 1 to the birdcage comprising:
an extension spring or other flexible means according to claim 1 whereby said object creates flexibility for said perch body to move randomly. Not only front to back motion.

4. A protective object or material according to claim 1 to protect the birds feet from becoming entangled in said flexible means according to claim 3 comprising:
a protective object or material inserted into the interior of said flexible means according to claim 3; and
a protective object or material over the exterior of said flexible means according to claim 3.
